(19) United States
(12) Patent Application Publication
(10) Pub. No.: US 2011/0180435 A1
(43) Pub. Date: Jul. 28, 2011

(54) METHOD FOR COMBINING COMPONENTS AND SHELL OBTAINED THEREBY

(75) Inventors: FENG JIN, Shenzhen City (CN); GEN-PING DENG, Shenzhen City (CN); CHUN-CHI CHEN, Tu-Cheng (TW)

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/758,806

(22) Filed: Apr. 13, 2010

(30) Foreign Application Priority Data
Jan. 25, 2010 (CN) 201010300673.0

(51) Int. Cl. B65D 85/00; B23K 31/02; B23K 26/00

(52) U.S. Cl. 206/320; 228/101; 228/175; 219/121.64

(57) ABSTRACT

An exemplary combining method includes the following. Firstly, providing two components and a connector. Secondly, welding the connector to one of the two components, and securing the other one of the two components to the connector.

### BACKGROUND

1. Technical Field

The present invention relates to a method for combining components, and more particularly to a method for combining components made of different materials. The present invention also relates to a shell of an electronic device obtained by carrying out the method.

2. Description of Related Art

Conventionally, a shell of an electronic device, such as an MP3 (MPEG, audio layer 3) player, a camera, or a mobile phone, is obtained by welding plural components together. However, the components for the shell are typically made of different materials. For example, when there are two components welded together, the welding temperature needs to be at least as high as the higher of the two melting points of the components. Yet such a temperature is liable to damage or even destroy the component with the lower of the two melting points.

For the foregoing reasons, there is a need for a method which safely and effectively combines components made of different materials; and there is a need for a shell obtained by carrying out such method.

### BRIEF DESCRIPTION OF THE DRAWINGS

FIG. 1 is a flow chart of a method in accordance with an embodiment of the present invention.

FIG. 2 is an exploded view of two parts of a shell to be combined by the method of FIG. 1, the two parts being a cover and a chassis.

FIG. 3 is an enlarged view of part of the chassis of FIG. 2.

FIG. 4 is an exploded view of FIG. 3.

FIG. 5 is an assembled view of the shell of FIG. 2.

FIG. 6 is an enlarged view of a circled portion VI of FIG. 2.

FIG. 7 is an enlarged view of a circled portion VII of FIG. 3.

### DETAILED DESCRIPTION

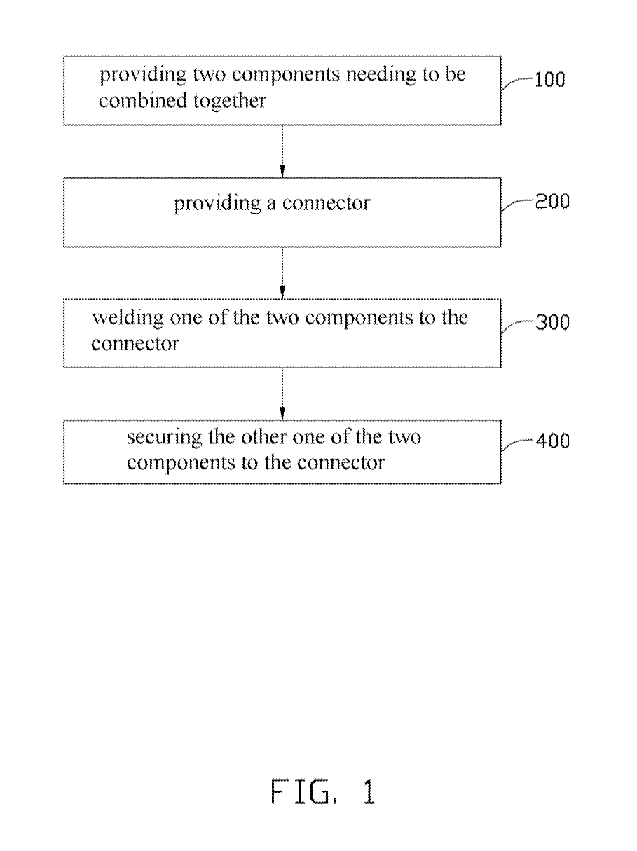

FIG. 1 shows steps of a method for combining plural components in accordance with an embodiment of the present invention. The method includes the steps of: a) providing two components needing to be combined together; b) providing a connector; c) welding one of the two components to the connector; and d) securing the other one of the two components to the connector. Exemplary details of the method are given below.

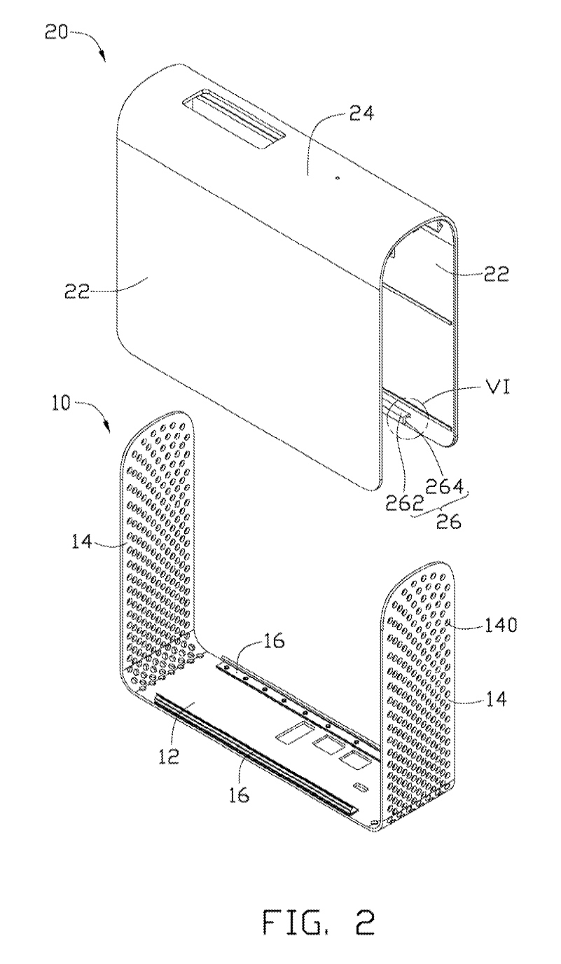

Referring to FIGS. 2-4, in a typical application, the method is used to combine components of a shell of an electronic device. The shell includes a chassis 10, two tracks 16, two connectors 18, and a cover 20. The connectors 18 are configured for combining the tracks 16 to the chassis 10. The cover 20 is connected to the tracks 16.

The chassis 10 is made of aluminum. Referring to FIG. 2, the chassis 10 is a U-shaped sheet, and includes an elongated base 12 and two elongated sidewalls 14 extending upwardly from opposite ends of the base 12, respectively. The sidewalls 14 are perpendicular to the base 12. Top ends of the sidewalls 14 are chamfered. In particular, the top ends of the sidewalls 14 are rounded with curved fillets. A joint of each of the sidewalls 14 and the base 12 is also rounded, substantially in the form of a curved fillet. A plurality of through holes 140 are defined in the sidewalls 14, for providing ventilation.

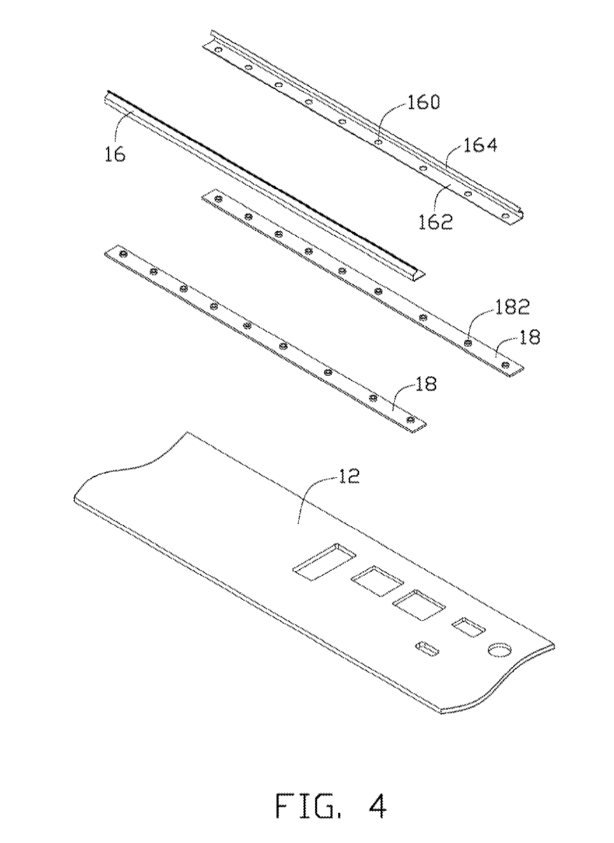

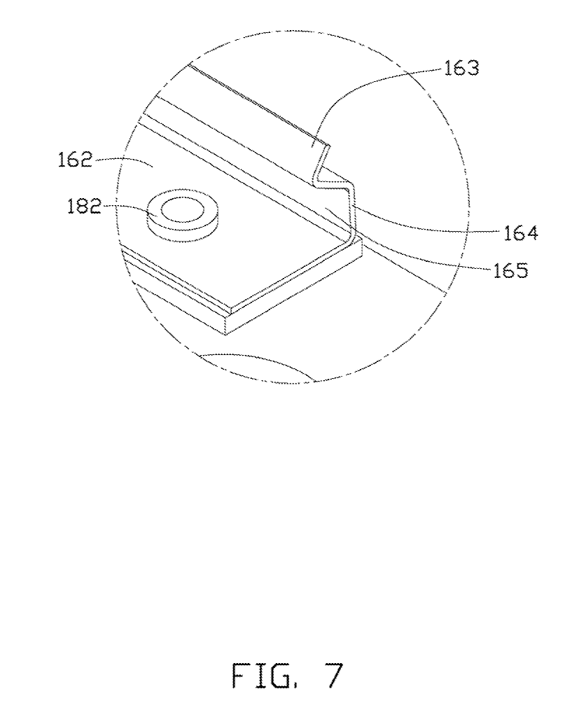

Referring to FIG. 4 and FIG. 7, the tracks 16 are made of stainless steel. Each track 16 includes an elongated mounting plate 162, and a generally L-shaped baffling plate 164 extending upwardly from a long lateral side of the mounting plate 162. The baffling plates 164 of the two tracks 16 are symmetrically opposite each other, and oriented generally towards each other. A plurality of through holes 160 are defined in the mounting plate 162 of each track 16. The through holes 160 are arranged along a longitudinal direction of the mounting plate 162. The baffling plate 164 and the mounting plate 162 cooperatively define a through groove 165 therebetween. A stretching plate 163 extends upwardly from a top long edge of the baffling plate 164. The stretching plate 163 and a top portion of the baffling plate 164 cooperatively form a generally V-shaped configuration.

The connectors 18 are made of aluminum. Each connector 18 is elongated, and includes a plurality of spaced posts 182 protruding upwards therefrom, the posts 182 corresponding to the through holes 160 of the respective mounting plate 162. The posts 182 are arranged along a longitudinal direction of the connector 18. The elongated connectors 18 are slightly shorter than the corresponding length of the base 12 of the chassis 10. A size of the mounting plate 162 is approximately equal to that of the connector 18.

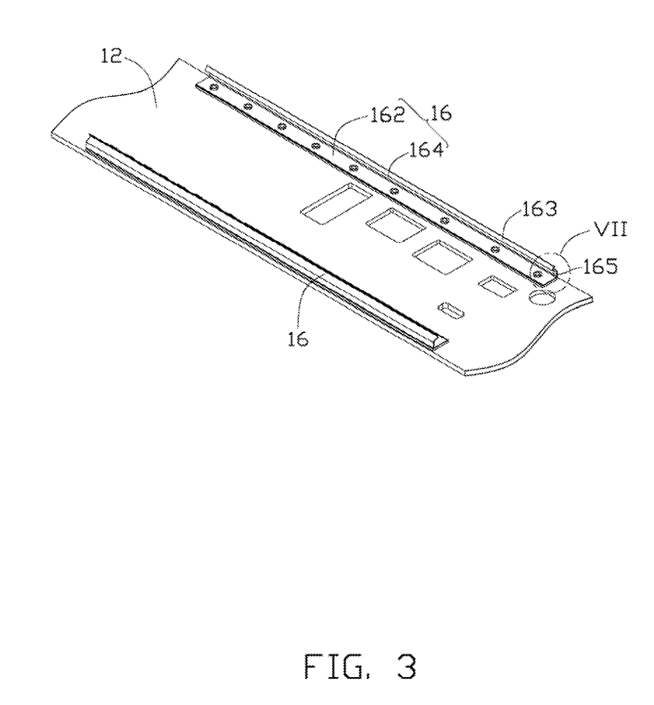

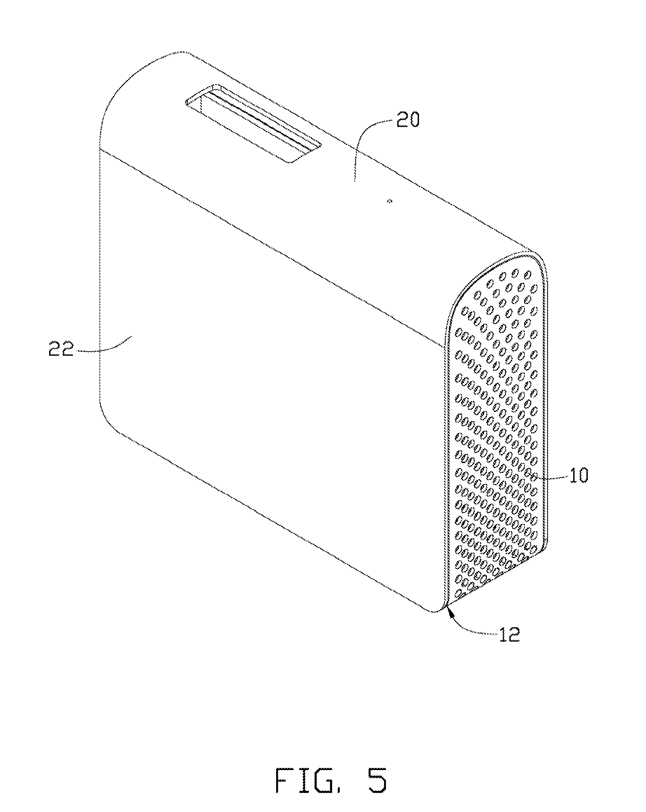

Referring to FIGS. 3-5, when combining the tracks 16 to the chassis 10, firstly, the connectors 18 are mounted into the chassis 10. A bottom flat side of each connector 18 contacts a top side of the base 12 of the chassis 10. The connectors 18 are respectively disposed on opposite lateral long sides of the base 12. Each connector 18 is generally centered on a middle of the lateral long side of the base 12, with the opposite ends of the connector 18 spaced from the sidewalls 14 a same distance. Then the connectors 18 are welded to the base 12 by laser welding.

The tracks 16 are then mounted to the connectors 18 as follows. The through holes 160 of the mounting plates 162 are aligned with the posts 182 of the connectors 18. The mounting plates 162 are pressed onto the connectors 18 to make the posts 182 extend through the through holes 160. In this embodiment, the posts 182 are slightly larger than the through holes 160 in diameter, and the posts 182 are engaged in the through holes 160 by interference fit. Thus, the tracks 16 are secured on the connectors 18. Alternatively, if the posts 182 are not larger than the through holes 160 in diameter, the posts 182 can protrude up from the through holes 160 after being inserted through the through holes 160. The posts 182 can then be hammered (i.e. riveted) to fix the connectors 18 to the base 12 of the chassis 10.

As described above, to achieve the combination of the tracks 16 and the chassis 10, the aluminous connectors 18 are welded on the aluminous base 12 of the chassis 10, and then the tracks 16 are connected to the connectors 18. This avoids the tracks 16 and the base 12 having to be welded directly together. The melting point of the stainless steel tracks 16 is higher than that of the aluminous base 12. Thus, the chassis 10 avoids bearing a high welding temperature corresponding to the high melting point of the stainless steel tracks 16, and thereby avoids deformation that would be caused by such high welding temperature. In this embodiment, the connectors 18 and the base 12 of the chassis 10 are both aluminum, and accordingly have the same melting point. It should be understood that in alternative embodiments, the connectors 18 and the chassis 10 can be made of different materials which have melting points approximately the same as each other.

After the tracks 16 are combined to the base 12 of the chassis 10, bottom surfaces of the mounting plates 162 contact top surfaces of the connectors 18. The baffling plates 164 are oriented toward each other. The stretching plates 163 are symmetrically opposite each other, and oriented generally away from each other. The top cover 20 can thus be connected to the tracks 16 (see below).

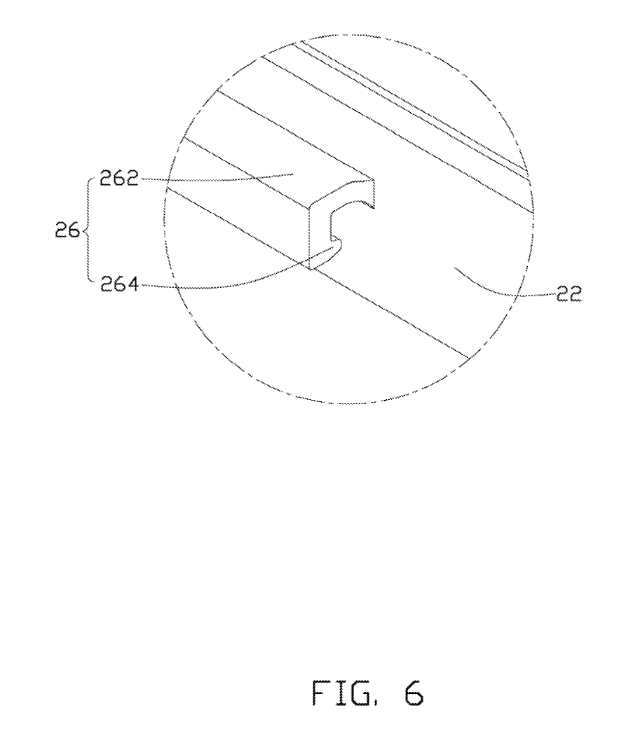

Referring to FIG. 2 and FIG. 6, the top cover 20 is a U-shaped sheet, and includes two spaced and parallel extending plates 22 and a convex connecting plate 24. Opposite edges of the connecting plate 24 adjoin top edges of the two extending plates 22, respectively. A bottom end of an inner surface of each of the extending plates 22 has a securing member 26 extending therefrom. The securing member 26 is centered on a middle portion of the bottom end of the extending plate 22. The securing member 26 includes an elongated top flange 262 perpendicularly extending from the inner surface of the extending plate 22, and an L-shaped spreading portion 264 extending downwardly from a free edge of the top flange 262. The spreading portion 264 is spaced from the inner surface of the extending plate 22.

In assembly of the top cover 20 onto the chassis 10, the extending plates 22 of the top cover 20 are pulled apart from one another slightly to span over upper portions of the sidewalls 14 of the chassis 10. The extending plates 22 are released so that lateral sides of the extending plates 22 abut edges of upper portions of the sidewalls 14. The top cover 20 is slid down towards the base 12, and eventually the spreading portions 264 of the securing member 26 contact the stretching plates 163 of the tracks 16. The spreading portions 264 ride down along the stretching plates 163 until the spreading portions 264 are snappingly engaged in the grooves 165 of the tracks 16, respectively. Thereby, the lateral sides of the extending plates 22 are securely held in position abutting the edges of the sidewalls 14. Thus, the top cover 20 and the chassis 10 are attached together, and the shell is obtained.

It is to be understood, however, that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method for combining two components, comprising:
providing a first component made of a first material;
providing a second component and a connector, the second component being made of a second material different from the first material, a melting temperature of the second component being higher than that of the first component, and a melting temperature of the connector being at least approximately equal to that of the first component;
welding the connector to the first component by laser welding; and
securing the second component on the connector.

2. The method of claim 1, wherein the second component is made of metallic material.

3. The method of claim 1, wherein the second component is interferingly secured with the connector.

4. The method of claim 3, wherein a post protrudes from the connector, a through hole is defined in the second component, and the post of the connector is interferingly engaged in the through hole of the second component.

5. The method of claim 1, wherein the connector is made of the same material as the first component.

6. A shell for an electronic device, comprising:
a chassis made of a first material;
a first connector welded to the chassis, the first connector made of a second material, a melting temperature of the second material of the first connector at least approximately equal to that of the first material of the chassis;
a second connector connected to the first connector, the second connector made of a third material, a melting temperature of the third material of the second connector being higher than that of the first material of the chassis; and
a cover comprising a securing member engaged with the second connector, the cover thereby attached to the chassis.

7. The shell of claim 6, wherein the chassis comprises a base, the first connector comprises two elongated sheets respectively welded to opposite sides of the base, the second connector comprises two mounting plates mounted on the two elongated sheets of the first connector, respectively, and two baffling plates extending from the mounting plates, respectively, and the securing member comprises two spreading portions snappingly engaging with the baffling plates of the second component, respectively.

8. The shell of claim 7, wherein a plurality of posts protrude from the sheets of the first connector, a plurality of holes are defined in the mounting plates of the second connector, and the posts are interferingly engaged in the holes.

9. The shell of claim 7, wherein the chassis further comprises two sidewalls extending upwardly from two ends of the base, and a plurality of through holes are defined in the sidewalls.

10. The shell of claim 9, wherein the cover comprises a connecting plate and two extending plates extending downwardly from opposite sides of the connecting plate, and the spreading portions of the securing member protrude from inner surfaces of the extending plates, respectively.

11. The shell of claim 10, wherein the securing member further comprises two top flanges extending from the extending plates, respectively, and the spreading portions extend downwardly from the top flanges, respectively.

12. The shell of claim 10, wherein the sidewalls of the chassis are sandwiched between the extending plates of the cover.

13. The shell of claim 7, wherein the second connector further comprises two stretching plates, which extend upwardly and outwardly from top edges of the baffling plates, respectively.

14. A method of combining two components, the method comprising:
providing two components and a connector; and
welding the connector to one of the two components, and securing the other one of the two components to the connector.

15. The method of claim 14, wherein the melting points of the connector and the one of the two components are at least approximately the same as each other, while the melting point of the other one of the two components is higher than that of the connector.

16. The method of claim 15, wherein the two components are made of different metallic materials, and the connector is made of the same material as the one of the two components.

17. The method of claim 14, wherein the connector is welded to the one of the two components by laser welding.

18. The method of claim 14, wherein the connector is secured to the other one of the two components by interference fitting or riveting.
